(19) United States
(12) Patent Application Publication
(10) Pub. No.: US 2011/0053506 A1
(43) Pub. Date: Mar. 3, 2011

(54) Methods and Devices for Controlling Particular User Interface Functions of a Mobile Communication Device in a Vehicle

(75) Inventors: Mark R. Lemke, Mundelein, IL (US); William S. Hede, Lake in the Hills, IL (US)

(73) Assignee: Motorola, Inc., Schaumburg, IL (US)

(21) Appl. No.: 12/548,920

(22) Filed: Aug. 27, 2009

(51) Int. Cl. H04B 7/00; H04B 17/00

(52) U.S. Cl. 455/41.2; 455/67.11

(57) ABSTRACT

Disclosed are methods and devices for controlling particular user interface functions of a mobile communication device when the device is used by a driver of a moving vehicle. A disclosed method includes determining if the mobile communication device is within a predetermined proximity to the driver's seat. The method further includes determining if the mobile communication device is moving at a predetermined speed or acceleration. When those conditions are met, the method includes substantially disabling particular user interface functions of the mobile communication device. Particular user interface functions that may be disabled or inhibited may include, for example, at least one of a display function, a keypad function or a touchscreen function. In this way, a driver may not be able to utilize one or more particular user interface functions while driving.

### FIELD

Disclosed are methods and devices for controlling particular user interface functions of a mobile communication device in a vehicle, and particularly if the mobile communication device is proximal to the driver's seat of the vehicle, and if the vehicle is in motion.

### BACKGROUND

The makers of mobile communication devices, including those of cellular telephones, are increasingly adding functionality to their devices. For example, cellular telephones include features such as still and video cameras, video streaming and two-way video calling, email functionality, Internet browsers, music players, FM radios with stereo audio and organizers. Bluetooth enabled cellular telephones may be PC compatible so that files generated or captured on the mobile communication device may be downloaded to a PC. Likewise, data from a PC or other source may be uploaded to the mobile communication device. Moreover, a cellular user may download music and movies to their mobile communication device as well. Cellular telephones in particular are becoming more than simply mobile communication devices. They are evolving into powerful tools for information management as well as entertainment consoles.

The makers of mobile communication devices also strive to improve the overall experience by the user of the device. In addition to increasing functionality, a maker of the device may wish to improve on already existing functionalities. For example, in text messaging, improved accuracy of the input of the text may be desired. Different types of improvements to the functionality of mobile communication devices are sought to improve the overall experience.

### BRIEF DESCRIPTION OF THE DRAWINGS

FIG. 1 depicts an embodiment of a system that can include a mobile communication device, a vehicle and a remote server that may be in communication with one another;

FIG. 2 depicts a block diagram representing example internal components of a mobile communication device that may be used for an embodiment in accordance with the present invention;

FIG. 3 depicts a block diagram representing example internal components of a vehicle that may be used for an embodiment in accordance with the present invention;

FIG. 4 depicts an embodiment of a four seat vehicle taken from a view above the passenger compartment;

FIG. 5 is a signal flow diagram depicting communication between the mobile communication device, a vehicle and optionally a remote server; and

FIG. 6 is a flowchart of an embodiment of a method for controlling particular user interface functions of a mobile communication device in a vehicle.

### DETAILED DESCRIPTION

Disclosed are methods and devices for controlling particular user interface functions of a mobile communication device when the device is used by a driver of a moving vehicle. A disclosed method includes determining if the mobile communication device is within a predetermined proximity to the driver's seat. Additionally, it may be determined whether there is a driver in the driver's seat. In this way it may be determined if the driver of the vehicle is with a predetermined proximity to the mobile communication device, it would be likely that if the mobile communication device is utilized, it would be utilized by the driver.

The method further includes determining if the mobile communication device is moving at a predetermined speed or acceleration when it is determined that the mobile communication device is within a predetermined proximity to the driver's seat. When those conditions are met, the method includes substantially disabling particular user interface functions of the mobile communication device. Particular user interface functions that may be disabled or inhibited may include, for example, at least one of a display function, a keypad function or a touchscreen function. In this way, a driver may not be able to utilize one or more particular user interface functions while driving.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

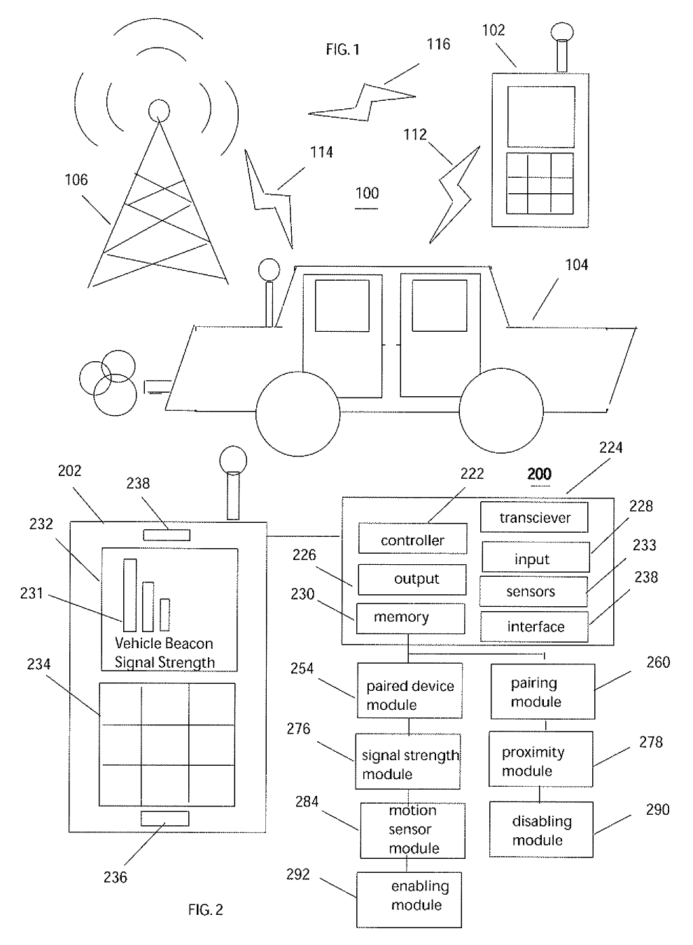

FIG. 1 depicts an embodiment of a system 100 that can include a mobile communication device 102, a vehicle 104 and a remote server 106 that may be in communication 110, 112 and 114 with one another. The mobile communication device 102 and the vehicle 104 may be in communication for a variety of reasons. In one embodiment, the vehicle 104 may determine whether the mobile communication device 102 includes an application for controlling particular user interface functions of a mobile communication device. If a vehicle 104, or a remote server 106, determines that the mobile communication device 102 does not include an application for controlling particular user interface functions of a mobile communication device, the vehicle 104 or the remote server 106 may download the application to the mobile communication device 102. Other types of communication between the mobile communication device 102, the vehicle 104 and/or the remote server 106 are discussed below. It is understood that any manner in which to communicate is within the scope of this discussion.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The server 106 is depicted as a remote server within a wireless communication network 108. The network 108 of course may be any type of wireless network including an ad hoc or wireless personal area network, a WiFi or wireless local area network, and a cellular or wireless wide area network. The server 106, for example, may receive and transmit Global Positioning Satellite (GPS) data. Likewise, the server 106 may be of any suitable configuration. The server 106 may be implemented as a single server or as a plurality of servers in communication in any arrangement. The operations of the server 106 may be distributed among different servers or devices that may communicate in any manner. It is understood that the depiction in FIG. 1 is for illustrative purposes.

FIG. 2 depicts a block diagram representing example internal components 200 of a mobile communication device 202 that may be used for an embodiment in accordance with the present invention. The example embodiment includes a controller or processor 222, one or more wireless transceivers 224, one or more output components 226, and one or more input components 228, and a memory 230. Each embodiment may include one or more user interface components that are in communication with one or more output components 226 and one or more input components 228. User interface components may include, for example, at least one of a display screen 232, a keypad 234 or a touchscreen function incorporate into or separate from the display screen 232. A microphone 236 and a speaker 238 may be in communication with one or more output components 226 and one or more input components 228.

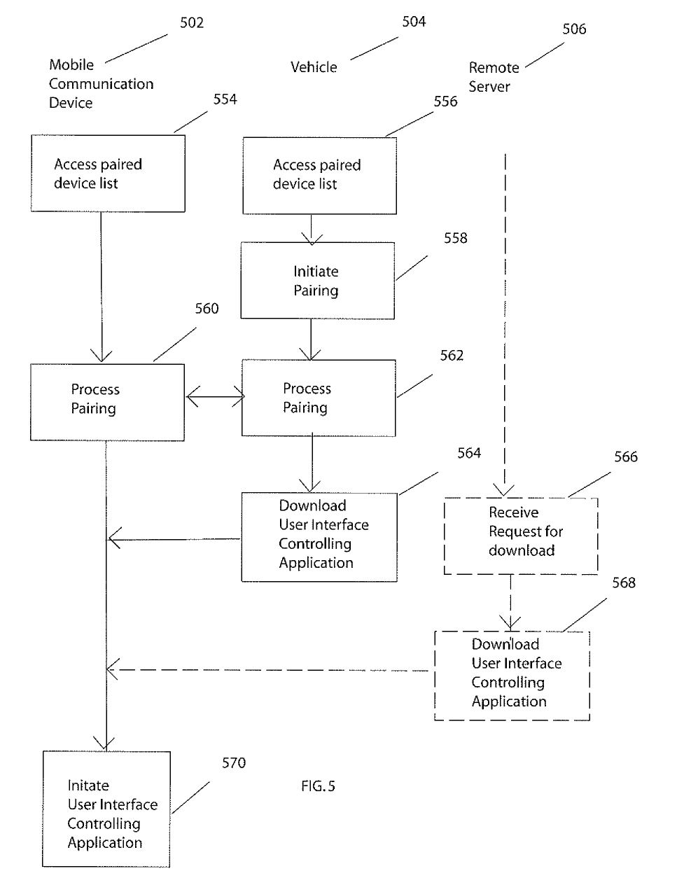

As will be described in more detail below, an application for controlling particular user interface functions of a mobile communication device is configured to determine if the mobile communication device 202 is within a predetermined proximity to the driver's seat of a vehicle 104. FIG. 4 depicts an embodiment of a four seat vehicle 404 taken from a view above the passenger compartment where a mobile communication device 202 may be placed in any position with respect to a beacon device 442 (see FIG. 4). In addition to other criteria, when it is determined if the mobile communication device is outside of or out of range of a predetermined proximity to the driver's seat by determining the signal strength of the beacon's signal, particular user interface functions of the mobile communication device may not be disabled. For illustrative purposes of this discussion, and/or in actual practice, on the display device 232 of the mobile communication device 202 a visual display of the signal strength 231 of the beacon's signal 452 received by the mobile communication device 202 is depicted. Alternatively, or additionally, an indication of the signal strength the beacon's signal 452 may be audibly annunciated or annunciated in any suitable manner. The benefits of indicating the vehicle beacon signal strength 231 to a user may vary depending upon the circumstances.

Each wireless transceiver 224 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants, as represented by cellular transceiver. Each wireless transceiver 224 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by WLAN transceiver. Also, each transceiver 224 may be a receiver, a transmitter or both.

The processor 222 may generate commands based on information received from one or more input components 228, one or more sensors 233, and/or one or more transceivers. The processor 222 may process the received information alone or in combination with other data, such as the information stored in the memory 230. Thus, the memory 230 of the internal components 200 may be used by the processor 222 to store and retrieve data. The data that may be stored by the memory 230 include, but is not limited to, operating systems, applications, and data. Each operating system includes executable code that controls basic functions of the portable electronic device, such as interaction among the components of the internal components 200, communication with external devices via each transceiver 224 and/or a device interface such as a Bluetooth headset, and storage and retrieval of applications and data to and from the memory 230.

The input components 228 of the internal components 200 may include a video input component such as an optical sensor (for example, a camera), an audio input component such as a microphone, and a mechanical input component such as button or key selection sensors, touch pad sensor, touch screen sensor, capacitive sensor, motion sensor, and switch. Likewise, the output components 226 of the internal components 200 may include a variety of video, audio and/or mechanical outputs. For example, the output components 226 may include a video output component such as a cathode ray tube, liquid crystal display, plasma display, incandescent light, fluorescent light, front or rear projection display, and light emitting diode indicator. Other examples of output components 226 include an audio output component such as a speaker, alarm and/or buzzer, and/or a mechanical output component such as vibrating or motion-based mechanisms.

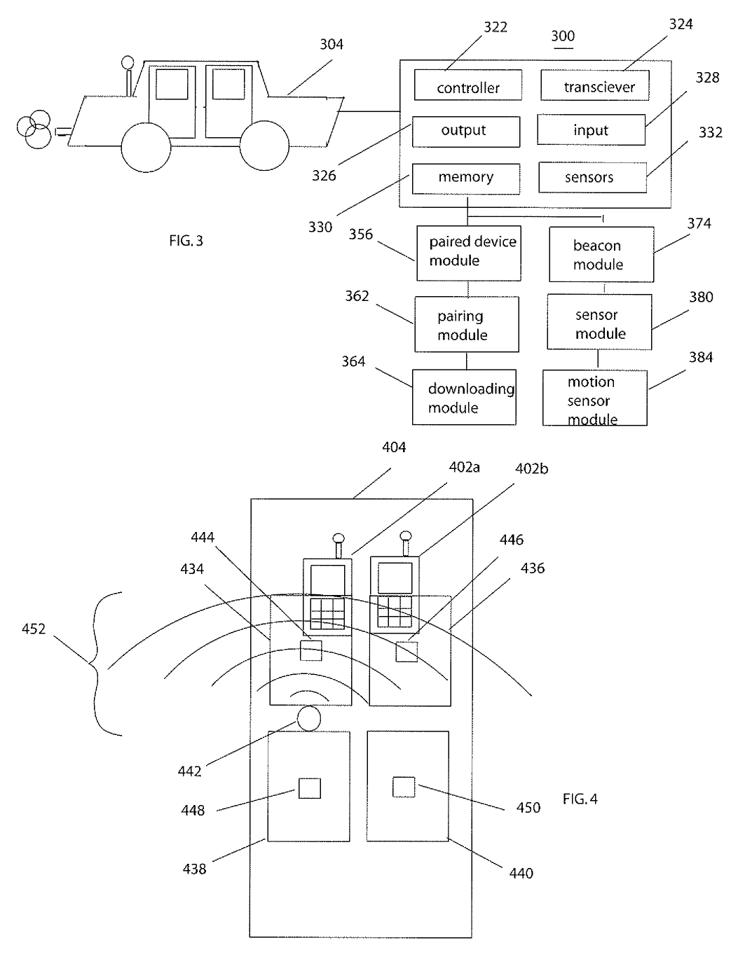

The sensors 233 are similar to the input components 228, and some of which are particularly identified separately in FIG. 3 due to their importance for the present invention. The sensors 233 may also include one or more other sensors. Examples of these other sensors 233 include, but are not limited to, proximity sensors, accelerometers, touch sensors, surface/housing capacitive sensors, and video sensors (such as a camera). For example, an accelerometer may be embedded in the electronic circuitry of the portable electronic device 202 to show whether the device is stationary, has a velocity and/or acceleration. Touch sensors may used to indicate whether the device is being touched, thus indicating whether or not the device is potentially in use at any particular time.

The internal components 200 may further include a device interface 238 to provide a direct connection to auxiliary components or accessories, such as a Bluetooth headset, for additional or enhanced functionality. In addition, the internal components 200 preferably include a power source, such as a portable battery, for providing power to the other internal components and allow portability of the portable electronic device 202.

The methods for controlling particular user interface functions of a mobile communication device 202 in a vehicle 104 (see FIG. 1) may be carried out by a combination of the internal components 200 and modules stored in a memory 230 of the device and/or internal components 300 (see FIG. 3) and modules of memory 330 of the vehicle 304. A disclosed method includes determining if the mobile communication device 202 is within a predetermined proximity to the driver's seat 434 (see FIG. 4), determining if the mobile communication device 202 is moving at a predetermined speed or acceleration in accordance with one or more sensors and/or for example, GSP received data, when it is determined that the mobile communication device is within a predetermined proximity to the driver's seat 434 and substantially disabling particular user interface functions of the mobile communication device 202 when it is determined that the mobile communication device 202 is moving at a predetermined speed or acceleration. Particular user interface functions that may be disabled or inhibited may include, for example, at least one of a display function of a display device 233, a keypad function of a keypad 234 and/or a touchscreen function of a display device 233 or keypad 234 or other display device.

Modules may include a proximity module 278 configured to determine if the mobile communication device is within a predetermined proximity to a driver's seat 434 (see FIG. 4) of a vehicle 104 and a motion sensor module 284 configured to determine if the mobile communication device 202 is moving at a predetermined speed or acceleration. A disabling module 290 configured to substantially disable particular user interface functions of the mobile communication device 202 when it is determined that the mobile communication device 202 is moving at a predetermined speed or acceleration.

If the above-discussed conditions are met so that the mobile communication device 202 will substantially disable one or more user interface functions, the disabling module 290 which is configured to substantially disable at least one of a display function, a keypad function or a touchscreen function may carry out this operation. Moreover, under the same or similar circumstance an enabling module 292 may automatically enabling other user interface functions, for example, a voice control function.

The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

FIG. 3 depicts a block diagram representing example internal components 300 of a vehicle 304 that may be used for an embodiment in accordance with the present invention. The example embodiment includes a controller or processor 322, one or more wireless transceivers 324, one or more output components 326, and one or more input components 328, a memory 330 and one or more sensors 332.

As mentioned, the mobile communication device 102 and the vehicle 104 may be in communication for a variety of reasons. In one embodiment, the vehicle 104 may determine whether the mobile communication device 102 includes an application for controlling particular user interface functions of a mobile communication device. If a vehicle 304 determines that the mobile communication device 102 does not include an application for controlling particular user interface functions of a mobile communication device, the vehicle 304 may download the application to the mobile communication device 102 in accordance with a downloading module 364.

As discussed above, a disclosed method includes determining if the mobile communication device 102 is within a predetermined proximity to the driver's seat 434 (see FIG. 4). A beacon activation module 374 may be configured to activate a beacon device 442 (see FIG. 4) proximal to the driver's seat 434 to generate a beacon signal 452. Briefly returning to FIG. 2, a signal strength module 276 (see FIG. 2) of the mobile communication device 202 may be configured to determine signal strength of a beacon signal generated by a beacon device 442 proximal to the driver's seat 434. A determination of the strength of the beacon signal can indicate the location of the mobile communication device 202 with respect to the driver's seat 434 in accordance with a proximity module 278 configured to assess proximity of the mobile communication device to the driver's seat based on the signal strength of the beacon signal.

Additionally, it may be determined whether there is a driver in the driver's seat in accordance with a sensor 444 (see FIG. 4), for example, placed in the driver's seat 434. A sensor module 380 may be configured to determine whether the driver's seat 434 (see FIG. 4) is occupied, and if one or more non-driver seats are occupied. In this way it may be determined if the driver of the vehicle is with a predetermined proximity to the mobile communication device, it would be likely that if the mobile communication device is utilized, it would be utilized by the driver.

FIG. 4 depicts an embodiment of a four seat vehicle 404 taken from a view above the passenger compartment. Of course, a vehicle 404 can be any configuration, such as a motorcycle or a bus. In the instant embodiment there is a driver's seat 434, a non-driver seat next to the driver's seat 436, and two back seats 438 and 440. Each seat may come with a headrest. A beacon device 442 for example, may be positioned within the headrest of the driver's seat 436 or in any other suitable location. Each seat may have a sensor, such as a pressure sensor, 444, 446, 448 and 450. The beacon device 442 may generate a signal 452, such as a low level directional signal, that can be detected by a mobile communication device 402. Depending upon where the mobile communication device 402 is in the vehicle with respect to the beacon device 442, the signal strength of the beacon signal 452 received by the mobile communication device 402 can indicate the proximity of the mobile communication device 402 with respect to the driver's seat.

FIG. 4 depicts the mobile communication device 402a substantially in the vicinity of the driver's seat 434. If instead the mobile communication device 402b were in the vicinity of the non-driver's seat 436, then the signal strength of the beacon signal 452 would not be a strong as it would be were it proximal the driver's seat 434. If the determined signal strength of the beacon signal 452 were such that mobile communication device 402b was proximal the non-driver seat 436 it could be determined that the mobile communication device 402b is not being used by the driver of the vehicle 404. However, that determination may not be substantially conclusive unless a sensor 446 such as a pressure sensor in the non-driver seat could sense the weight of a non-driver. If it were determined that a non-driver was in the non-driver seat 436, then it could be assumed that any use of the mobile communication device 402 was by a non-driver, and not by the driver. Accordingly, determining if a non-driver seat 436 is occupied and even though it is determined that the mobile communication device 402b is within a predetermined proximity to the driver's seat 434 (e.g. close enough to the driver's seat for the driver to reach the mobile communication device 402b), the particular user interface functions of the mobile communication device would not be disabled.

The method further includes determining if the mobile communication device 402a and/or 402b is moving at a predetermined speed or acceleration when it is determined that the mobile communication device is within a predetermined proximity to the driver's seat and optionally, that a non-driver is not in the non-driver seat 436. When those conditions are met, the method includes substantially disabling particular user interface functions of the mobile communication device 402a or 402b. Particular user interface functions that may be disabled or inhibited may include, for example, at least one of a display function, a keypad function or a touchscreen function. In this way, a driver may not be able to utilize one or more particular user interface functions while driving.

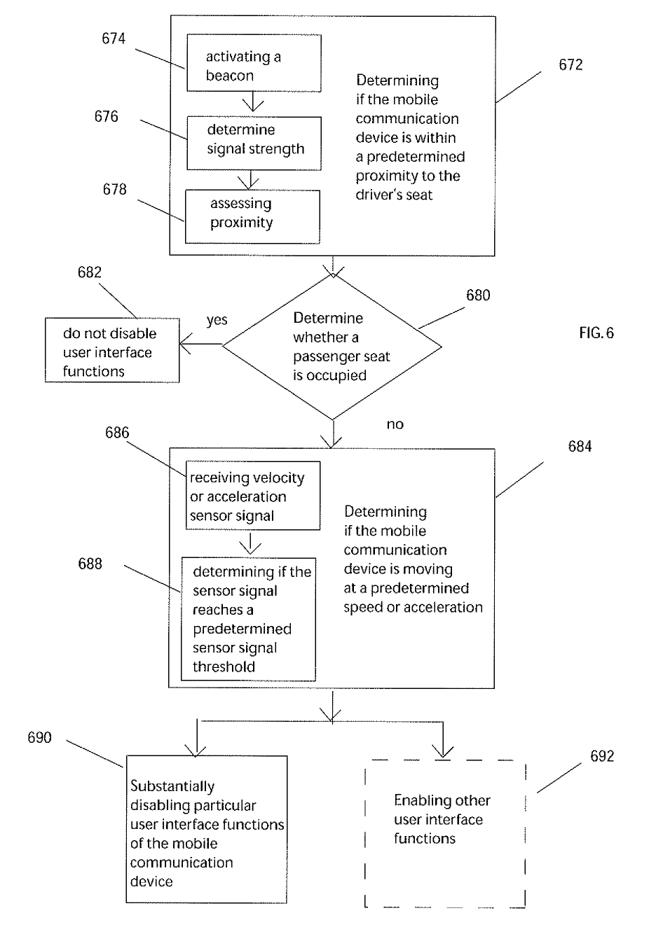

FIG. 5 is a signal flow diagram depicting pairing, for example, via Bluetooth communication between the mobile communication device 502, a vehicle 504 and optionally a remote server 506. There may be a need to pair the mobile communication device 502 and the vehicle 504, depending upon the type of communication between them. It is understood that the step of the described methods may be carried out by whichever device may suitably do so. For example, the first time a mobile communication device 502 and a vehicle 504 are with a predetermined proximity to one and other, the devices may become paired. In another example, a user of a mobile communication device 502 may drive a rental car instead of driving his/her own vehicle. A rental car company may allow that the mobile communication device of its customers support a method for controlling a user interface.

In any case, the mobile communication device 502 may become paired with the vehicle 504. Each would access a paired device list 554 and 556. Accordingly, a paired device modules 254 (see FIG. 2) and 362 (see FIG. 3) may be configured to determine if the mobile communication device 502 and a vehicle 504 are paired. One or the other may initiate pairing 558 and the pairing process may proceed 560 and 562 in accordance with the pairing modules 260 and 362 which may be configured to pair the mobile communication device 502 and the vehicle 504 if the mobile communication device 502 and the vehicle 504 are not paired. Once completed, the vehicle 504 may download 564 the user interface controlling application or request that a remote server 506, which could be, for example WIFI of a rental car facility, download the user interface controlling application. The remote server 506 can receive a request to download the application, and then download the application. The pairing process or the download, for example may provide the beacon device 442 (see FIG. 4) signal 452 frequency. The mobile communication device can initiate 570 the user interface controlling application.

FIG. 6 is a flowchart of an embodiment of a method for controlling particular user interface functions of a mobile communication device in a moving vehicle. As discussed above, the method includes determining 672 if the mobile communication device 102 (see FIG. 1) is within a predetermined proximity to the driver's seat 434 (see FIG. 4). Activating 674 the beacon device 442 (see FIG. 4) may be in accordance with a beacon activation module 374 (see FIG. 3). The signal strength of the beacon signal 452 can be determined 676 in accordance with a signal strength module 276 of the mobile communication device 202. Assessing proximity based upon the strength of the beacon signal can indicate the location of the mobile communication device 202 with respect to the driver's seat 434 in accordance with a proximity module 278.

As mentioned above, the mobile communication device 402b (see FIG. 4) may be determined to be proximal the non-driver's seat 436. It may be determined 680 whether the non-driver seat 436 proximal the mobile communication device 402b is occupied in accordance with a sensor module 380 (see FIG. 3). In that case, the user interface functions of the mobile communication device 402b may not be disabled 682. Determining 684 if the mobile communication device is moving at a predetermined speed or acceleration may be carried out in any suitable manner. The vehicle 104 (see FIG. 1) or the mobile communication device 102 may include one or more sensors to determine speed or acceleration. Moreover, a remote server 106 may provide such information, for example, GPS data. One or more speed and/or acceleration sensor modules 284 (see FIG. 2) and/or 384 (see FIG. 3) may receive 686 a velocity or an acceleration sensor signal. A determination 688 can be made if the sensor signal reaches a predetermined sensor signal threshold. It is understood that the velocity and/or acceleration signal of the device and/or the vehicle may be determined in any suitable manner.

If the above-discussed conditions are met so that the mobile communication device 102 (see FIG. 1) will substantially disable one or more user interface functions, the disabling module 290 (see FIG. 2) which is configured to substantially disable at least one of a display function, a keypad function or a touchscreen function may carry out this operation. Moreover, under the same or similar circumstance an enabling module 292 may automatically enable other user interface functions, for example, a voice control function for use in navigation applications, SMS, making and receiving phone calls. When using the voice activation application on the phone for the features listed below, the speakerphone can be automatically switched on or a Bluetooth headset can be used. When the above-discussed conditions are met, most particularly the method includes substantially disabling particular user interface functions of the mobile communication device. In this way, a driver may not be able to utilize one or more particular user interface functions while driving.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method for controlling particular user interface functions of a mobile communication device in a vehicle having a driver's seat, comprising:
determining if the mobile communication device is within a predetermined proximity to the driver's seat;
determining if the mobile communication device is moving at a predetermined speed or acceleration when it is determined that the mobile communication device is within a predetermined proximity to the driver's seat; and
substantially disabling particular user interface functions of the mobile communication device when it is determined that the mobile communication device is moving at a predetermined speed or acceleration.

2. The method of claim 1 further comprising:
determining if the mobile communication device and the vehicle are paired; and
pairing the mobile communication device and the vehicle if the mobile communication device and the vehicle are not paired.

3. The method of claim 1 further comprising:
determining if the mobile communication device includes a user interface controlling application; and
downloading to the mobile communication device a user interface controlling application when it is determined that the mobile communication device does not include a user interface controlling application.

4. The method of claim 3 wherein downloading to the mobile communication device a user interface controlling application, comprises:
initiating an application of the vehicle to download the user interface controlling application to the mobile communication device.

5. The method of claim 3 wherein downloading to the mobile communication device a user interface controlling application, comprises:
initiating an application of a remote server to download the user interface controlling application to the mobile communication device.

6. The method of claim 1 wherein determining if the mobile communication device is within a predetermined proximity to the driver's seat, comprises:
activating a beacon proximal to the driver's seat to generate a beacon signal; and
determining the signal strength of the beacon signal by the mobile communication device; and
assessing proximity of the mobile communication device to the driver's seat based on the signal strength of the beacon signal.

7. The method of claim 1 wherein determining if the mobile communication device is moving at a predetermined speed or acceleration, comprises:
receiving a velocity or acceleration sensor signal; and
determining if the sensor signal reaches a predetermined sensor signal threshold.

8. The method of claim 1 wherein disabling particular user interface functions of the mobile communication device, comprises:
substantially disabling a display function.

9. The method of claim 1 wherein disabling particular user interface functions of the mobile communication device, comprises:
substantially disabling a keypad function.

10. The method of claim 1 wherein disabling particular user interface functions of the mobile communication device, comprises:
substantially disabling a touchscreen function.

11. The method of claim 1 further comprising:
automatically enabling a voice control function.

12. The method of claim 1, wherein the vehicle includes a non-driver seat, the method further comprising:
determining if a non-driver seat is occupied; and
wherein upon determining if the mobile communication device is outside of or out of range of a predetermined proximity to the driver's seat and upon determining that a non-driver seat is occupied, not disabling particular user interface functions of the mobile communication device.

13. A method for controlling a user interface of a mobile communication device in a vehicle having a driver's seat, comprising:
determining if the mobile communication device includes a user interface controlling application configured to determine if the mobile communication device is within a predetermined proximity to the driver's seat and to determine if the mobile communication device is moving at a predetermined speed or acceleration when it is determined that the mobile communication device is within a predetermined proximity to the driver's seat; and
downloading to the mobile communication device a user interface controlling application when it is determined that the mobile communication device does not include a user interface controlling application.

14. The method of claim 13 wherein downloading to the mobile communication device a user interface controlling application, comprises:
initiating an application of the vehicle to download the user interface controlling application to the mobile communication device.

15. The method of claim 13 wherein downloading to the mobile communication device a user interface controlling application, comprises:
initiating an application of a remote server to download the user interface controlling application to the mobile communication device.

16. A mobile communication device, comprising:
a proximity module configured to determine if the mobile communication device is within a predetermined proximity to a driver's seat of a vehicle;
a sensor module configured to determine if the mobile communication device is moving at a predetermined speed or acceleration when it is determined that the mobile communication device is within a predetermined proximity to the driver's seat; and
a disabling module configured to substantially disable particular user interface functions of the mobile communication device when it is determined that the mobile communication device is moving at a predetermined speed or acceleration.

17. The device of claim 16 further comprising:
a paired device module configured to determine if the mobile communication device and a vehicle are paired; and
a pairing module configured to pair the mobile communication device and the vehicle if the mobile communication device and the vehicle are not paired.

18. The vehicle of claim 16 wherein determining if the mobile communication device is within a predetermined proximity to the driver's seat, comprises:
a beacon activation module configured to activate a beacon device proximal to the driver's seat to generate a beacon signal.

19. The mobile communication device of claim 16 further comprising:
a signal strength module configured to determine signal strength of a beacon signal generated by a beacon device proximal to the driver's seat; and
a proximity module configured to assess proximity of the mobile communication device to the driver's seat based on the signal strength of the beacon signal.

20. The device of claim 16 wherein the disabling module is configured to substantially disable at least one of a display function, a keypad function or a touchscreen function.
